(19) United States
(12) Patent Application Publication
(10) Pub. No.: US 2008/0141378 A1
(43) Pub. Date: Jun. 12, 2008

(54) METHOD AND APPARATUS FOR CREATING LICENSES IN A MOBILE DIGITAL RIGHTS MANAGEMENT NETWORK

(76) Inventor: Ivan Hugh MCLEAN, Solana Beach, CA (US)

Correspondence Address: QUALCOMM INCORPORATED, 5775 MOREHOUSE DR., SAN DIEGO, CA, 92121, US

(21) Appl. No.: 11/609,770

(22) Filed: Dec. 12, 2006

(51) Int. Cl. H04L 9/00

(52) U.S. Cl. 726/26

(57) ABSTRACT

Methods, devices, apparatus, computer-readable media and processors are provided that provide for the creation of licenses in a wireless digital rights management network. The aspects provide for the licensing rights to be generated at the wireless device and the digital authentication mechanism related to the rights generated at a network device. According to some aspects, the licensing rights may be based on wireless device-specific, usage rules that are determined at the wireless device. The media content license may subsequently be assembled either at the wireless device or at the network device.

### FIELD

The described aspects relate generally to wireless communication devices and network communication. More particularly, the described aspects relate to creating media content licenses in a mobile Digital Rights Management Network.

### BACKGROUND

Digital Rights Management (DRM) is a systematic approach to copyright protection for digital media. The purpose of DRM is to prevent illegal distribution of content over networks, such as the Internet. DRM systems were developed in response to the rapid increase in online piracy of commercially marketed material, which proliferated through the widespread use of peer-to-peer file exchange programs. Although copyright laws protect online content, policing the Web and catching law-breakers is very difficult. DRM technology focuses on making it difficult to steal content in the first place, thereby providing a much surer approach to the problem than the hit-and-miss strategies aimed at apprehending online poachers after-the-fact.

In a wireless or mobile network environment, the ability to protect digital rights becomes even more problematic as the ease by which attackers can intercept wireless transmissions increases. Thus, it is generally accepted that in a mobile DRM network, digitally authenticated DRM licenses, otherwise referred to as digitally signed DRM licenses, offer greater security against unauthorized modification than licenses that are not digitally authenticated.

DRM schemes that do not use digitally authenticated licenses are forced to protect the license against modification using methods that have been found to be unacceptable in terms of the security that they offer. For example, “secure” storage methods, systems that rely on the hiding of keys on the client device or software obfuscation, are all less desirable for various reasons. First, these suspect security methods do not offer “provable” security. In other words, it may be difficult to provide a measure to quantify the level of security provided by these methods. In contrast, the time required (i.e., work factor) to break a commonly used public key algorithm, for example a 1024 or 2048 bit RSA algorithm, is assumed to be well understood by those having knowledge in the art of cryptography. Secondly, successful attacks against such schemes tend to propagate well. Once an attacker figures out how client based keys are generated, or how they are stored, or the gist of the obfuscated software, then this information can be leveraged into a widespread attack, in which a utility is written, downloaded or distributed for use by the novice attacker.

In addition to security concerns, “secure” storage methods, key hiding methods and software obfuscation do not tend to work well on heterogeneous networks. In such networks, some original equipment manufacturers (OEMs) may have implemented very strong, hardware-based secure storage while other OEMs may have implemented weaker software-based secured storage and still others may not have implemented any storage security whatsoever. Such networking environments are very common, and result in a security situation that is extremely difficult to monitor and manage.

DRM schemes that use digitally authenticated licenses limit the attacker, who desires to perform an unauthorized modification of the rights contained in the license, to modifying the implementation itself. In a mobile or wireless network environment, modifying the implementation would generally entail reflashing the handset (i.e., re-programming the flash part), which is an attack that does not propagate well.

Thus, for the security reasons described above, the current trend within DRM schemes is reliance on digitally authenticated licenses. All of these current schemes rely on having the license generated and authenticated concurrently or in immediate succession by a relevant server, such as a licensing server or a content server. Therefore, a need exists to create an alternative method for implementing DRM in a mobile or wireless network environment. For example, a need exists to generate a DRM scheme that relies on authentication mechanisms, such as digital signatures or the like, but provides the ability to generate the licensing rights and a corresponding license authentication mechanism independent of each other. Thus, the desired DRM scheme will provide additional security, in that independent creation of the licensing rights and license authentication mechanism may further thwart the efforts of would be attackers or license manipulators.

### SUMMARY

Thus, devices, methods, apparatus, computer-readable media and processors are presented that provide for the creation of digitally authenticated licenses in a wireless digital rights management network. The aspects provide for the licensing rights to be generated at the wireless device in accordance with available licensing parameters associated with selected media content. The digital authentication mechanism is generated at a network device and communicated to the wireless device, either separately as an authentication mechanism or as part of an assembled digital media license. In some aspects, the wireless device will assemble the licensing rights and the authentication mechanism to create the digital media license. Thus, the present aspects provide for a highly secure means of protecting media content rights, insuring that media content rights are securely formed and, once formed, the authenticated license insures that rights are not susceptible to tampering or alteration by the licensee or another would be attacker.

In one aspect, a method for generating a media content license in a wireless network is provided. The method includes generating one or more proposed licensing rights related to selected media content, communicating the proposed licensing rights to a network device and receiving licensing rights validation, such as an authentication mechanism, thereby defining authenticated licensing rights. In some alternate aspects, the method may also include the step of assembling, at the wireless device, the licensing rights and the authentication mechanism to create a media content license. An alternate aspect is defined by a machine-readable medium that includes instructions, which, when executed by a machine, cause the machine to perform operations. The operations include generating, at a wireless device, one or more proposed licensing rights related to selected media content, communicating the proposed licensing rights to a network device and receiving, at the wireless device, licensing rights approval, such as an authentication mechanism, thereby defining authenticated licensing rights. In some aspects, the operations may additionally include assembling, at the wireless communication device, the licensing rights and the authentication mechanism to create a media content license.

Yet another aspect is defined by a processor device, implemented in a wireless device that is configured to perform the operations of generating one or more proposed licensing rights related to selected media content, communicating the proposed licensing rights to a network device and receiving licensing rights approval, such as an license authentication mechanism, thereby defining authenticated licensing rights. In some aspects, the processor may be additionally configured to perform the operation of assembling the licensing rights and the authentication mechanism to create a media content license.

In an alternate aspect, a wireless communication device is provided that includes a computer platform including a processing engine and a memory unit and a licensing rights module stored in the memory unit and executed by the processing engine. The licensing module is operable to present licensing options for selected media content, generate proposed licensing rights based on selected licensing options and communicate the proposed licensing rights to a network device for validation. In certain aspects licensing options are generated from an association between a licensing code associated with selected media content and available licensing parameters, such as usage terms, pricing information, device characteristics and the like.

In a related aspect, a wireless device is defined that includes a means for processing data on the wireless device, a means for storing data on the wireless device that is in communication with the means for processing data, a means for presenting licensing options for selected media content, a means for generating proposed licensing rights based on selected licensing options and a means for communicating the proposed licensing rights to a network device for validation.

An aspect is also defined by a system for creating digitally authenticated licenses in a wireless network. The system includes a wireless communication device that includes a computer platform that includes a processing engine, a memory unit and a licensing rights module that is stored in the memory unit and executed locally by the processing engine. The licensing rights module is operable to present licensing options for selected media content, generate proposed licensing rights based on selected licensing options and communicate the proposed licensing rights. Additionally, the system includes a network device in communication with the wireless device that comprises a computer platform that includes a processing engine, a memory unit and a license validation module stored in the memory unit and executed by the processing engine. The license validation module is operable to validate proposed licensing rights received from the wireless communication device and communicate a licensing rights validation to the wireless communication device.

According to an alternate aspect, a method for validating licensing rights within a wireless network is defined. The method includes receiving, at a network device, communication from a wireless device that includes proposed licensing rights associated with media content, validating, at the network device, the proposed licensing rights and communicating, to the wireless device, a licensing rights validation thereby defining authenticated licensing rights.

Another aspect is defined by a machine-readable medium that includes instructions, which, when executed by a machine, cause the machine to perform operations. The operations include receiving, at a network device, communication from a wireless device that includes proposed licensing rights associated with media content, validating, at the network device, the proposed licensing rights and communicating, to the wireless device, a licensing rights validation thereby defining authenticated licensing rights.

In a related aspect, a processor device, operable be a network device and configured to perform the operations of receiving communication from a wireless device that includes proposed licensing rights associated with media content, validating the proposed licensing rights and communicating, to the wireless device, a licensing rights validation thereby defining authenticated licensing rights.

In another aspect, a network device for validating licensing rights is defined. The device includes a computer platform that includes a processing engine and a memory unit and a license validation module stored in the memory unit and executed by the processing engine. The license validation module is operable to validate proposed licensing rights received from the wireless communication device and communicate a licensing rights validation to the wireless communication device.

Thus, the described aspects provide for alternative methods for generating digitally authenticated media content licenses in a wireless network environment. The disclosed aspects provide for systems that bifurcate license formation by generating the licensing rights at the wireless device and generating the associated authentication mechanism at a network device. As such, the proposed aspects provide for content media licenses that are highly secured and are not readily susceptible to alteration or attack.

### BRIEF DESCRIPTION OF THE DRAWINGS

The disclosed aspects will hereinafter be described in conjunction with the appended drawings, provided to illustrate and not to limit the disclosed aspects, wherein like designations denote the elements, an in which:

FIG. 1 illustrates one aspect of a system for creating digitally authenticated licenses in a wireless Digital Rights Management (DRM) network;

FIG. 2 illustrates one aspect of a wireless device for creating digitally authenticated licenses;

FIG. 3 illustrates one aspect of the content storage in a wireless device for creating digitally authenticated licenses;

FIG. 4 illustrates one aspect of a licensing options table as presented on a wireless device for choosing licensing options;

FIG. 5 illustrates one aspect of a network device for creating digitally authenticated licenses;

FIG. 6 illustrates one aspect of a second network device for communicating usage term handles to the wireless device;

FIG. 7 illustrates one aspect of a cellular telephone network for implementing the DRM network;

FIG. 8 is a flowchart of one aspect of a method for creating digitally authenticated licenses at a wireless device;

FIG. 9 is a flowchart of one aspect of a method for authenticating licensing rights at a network device.

### DETAILED DESCRIPTION

The present devices, apparatus, methods, computer-readable media and processors now will be described more fully hereinafter with reference to the accompanying drawings, in which aspects of the described embodiments are shown. The devices, apparatus, methods, computer-readable media and processors may, however, be embodied in many different forms and should not be construed as limited to the aspects set forth herein; rather, these aspects are provided so that this disclosure will be thorough and complete, and will fully convey the scope of the invention to those skilled in the art. Additionally, throughout this description, like numbers refer to like elements.

The present devices, apparatus, methods, computer-readable media and processors provide for the creation of digitally authenticated, media content licenses in a wireless Digital Rights Management (DRM) network. The described aspects provide for the licensing rights to be generated at the wireless device in accordance with selected usage rules and, in some aspects, wireless device attributes. In response to receiving proposed licensing rights having approvable terms, the described aspects provide validation of the proposed licensing rights to the wireless device. For example, an authentication mechanism may be generated at a network device and communicated to the wireless device, either as on its own or as part of an assembled media content license. In some aspects, the wireless device assembles the licensing rights and the authentication mechanism to create the media content license, thereby allowing access by the wireless device to the content based on licensing terms generated at the wireless device.

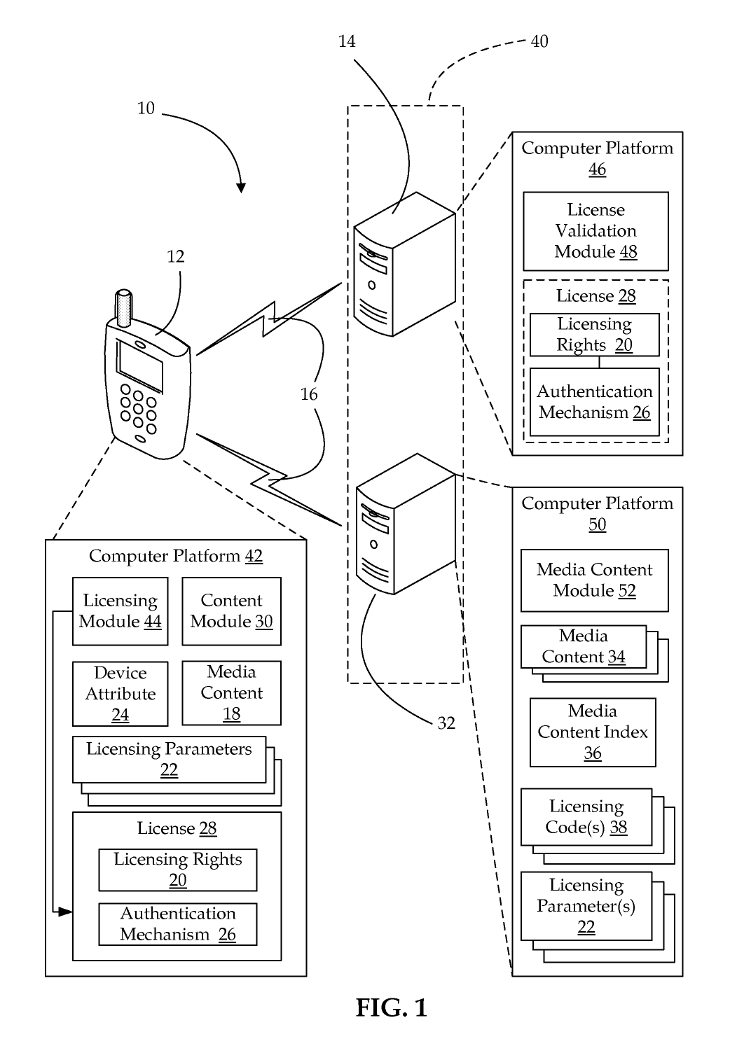

Referring to FIG. 1, one aspect is defined by a system 10 for creating digitally signed licenses on a wireless device in a wireless DRM network. The system 10 includes a wireless communication device 12 and a network device 14, such as the illustrated licensing server, in communication across a wireless network 16. For a protected piece of media content 18 to which the wireless device 12 desires access, the wireless device 12 locally generates licensing rights 20, including usage terms and/or pricing, selected from a plurality of licensing parameters 22. The available ones of the plurality of licensing parameters 22 may vary based on the requested media content 18, and in some aspects, may further vary depending on a wireless device attribute 24, as will be discussed below in more detail. Once the licensing rights 20 for the requested content 18 have been generated, the licensing rights, or a reference that corresponds to the generated licensing rights, are communicated from the wireless device 12 to the network device 14. The network device 14 validates the terms associated with the licensing rights 20, or the reference thereto, and generates a corresponding authentication mechanism 26, such as a digital signature, digital certificate, digital code, keyed hash or the like. Once the authentication mechanism 26 has been created with respect to the licensing rights 20 proposed by the wireless device 12, the network device 14 communicates the authentication mechanism 26 to the wireless device 12 and the wireless device 12 assembles and stores the licensing rights 20 and the authentication mechanism 26 as a digitally authenticated media content license 28. Optionally, the network device 14 may assemble the licensing rights 20 and the authentication mechanism 26 into a digitally authenticated media content license 28 and communicate the license to the wireless device. Thus, once in possession of a valid media content license 28, wireless device 12 may execute media content module 30 to access and present the respective licensed content 18.

The system 10 may optionally include a second network device 32, such as the illustrated media content server, which communicates with the wireless device 12 across wireless network 16 and provides the wireless device 12 with requested media content 18, which may be selected from a plurality of media content 34 resident on or accessible by the second network device 32. Additionally, in some aspects, the second network device 32 may provide for communicating to the wireless device 12 a media content index 36, which may include a reference, referred to herein as a licensing code 38, to usage terms and pricing information associated with the media content 34. As will be discussed in more detail below, the wireless device 12 uses the one or more licensing codes 38 associated with a given media content 18 to filter the available usage terms, pricing and other licensing-related conditions from the plurality of potential licensing parameters 22, thereby allowing a user of the wireless device 12 to select and generate licensing rights 20 to present to network device 14 for approval.

In some aspects, the licensing functionality of the network device 14 and the media content downloading functionality of second network device 32 may be embodied within a single, unitary network device (illustrated in FIG. 1 by block 40). It should also be noted that the aspects described herein are not limited by the existence of media content 18 on the wireless device. The communication of the media content 18 to the wireless device 12 may occur at any point in time before, during or after the creation of the digitally authenticated media content license. As such, the media content 18 may be downloaded or otherwise communicated to the wireless device 12 prior to the generation of licensing rights 20, at any point in time during the creation of the digitally authenticated license 28 or after the formation of the digitally authenticated license 28.

The wireless communication device 12 includes a computer platform 42 that can transmit data across wireless network 16, and that can receive and execute routines and applications. The computer platform 42 includes a licensing module 44 that generates licensing rights 20 for specified media content 18 based on selected licensing parameters 22 and, in some aspects, wireless device attributes 24. Initially, the licensing module 44 will determine, at the wireless device, terms that will be used to generate the licensing rights. In some aspects, the user of a media content module 30, which may operate in cooperation with licensing module 44, selects the terms. For example, media content module 30 may allow for the user to select from amongst various usage options, such as unlimited use, time period usage (e.g., one day, one month, etc.), play count based usage (e.g., one play, five plays, etc.) or the like.

In some aspects, the various usage term options and the corresponding prices of the options, which are presented by the media content module 30, may be based on device attributes 24 associated with the wireless device. The attributes 24 may include, but are not limited to, service or membership status (e.g., premier/gold service, standard service, member of a club associated with a content provider, etc.), geographic/physical location and/or network location associated with the wireless device or the device user, device security capabilities, hardware capabilities and the like. In this manner, the licensing parameters 22 which are available to the user of the wireless device 12 may differ amongst wireless devices based on the unique attributes associated with each respective wireless device.

Once the particular licensing parameters 22 for the selected media content 18 are selected, the licensing module 44 generates licensing rights 20. The licensing rights 20 may be directly defined by the selected one of the plurality of licensing parameters 22, or alternatively, the licensing rights 20 may further include other parameters, such as device-specific, network-specific, and/or content-specific parameters. In some aspects, the licensing module 44 may read the one or more licensing codes 38 associated with the requested content 18, and then rely on a look-up table that maps the one or more licensing codes 38 to available usage terms, pricing information and/or licensing conditions in the database of licensing parameters 22.

Once the proposed licensing rights 20 are generated, they are communicated to the network device 14 via wireless network 16. The network device 14 includes a computer platform 46 that can transmit data across wireless network 16, and that executes routines and applications. The computer platform 46 includes a license validation module 48 that confirms that the licensing rights 20 proposed by the wireless device 12 fall within the scope of available licensing rights for the given content and/or for the given wireless device. For example, license validation module 48 may compare the proposed licensing rights 20 with the authentic version of available licensing parameters 22 and the licensing codes 38 associated with the given content 18, such as by confirming this information with network device 32 and/or with a local copy of this information. If the terms of the licensing rights 20 are confirmed, then license validation module 48 is operable to cause the generation of an authentication mechanism 26, such as a digital signature or the like to validate the licensing rights 20. The term “authentication mechanism”, as used herein, may refer to any digital code typically employed in the art of network communications. For example, authentication mechanisms 26 may include an acceptable encryption algorithm, a cipher, a keyed hash, and/or a Message Authentication Code (MAC). Once the authentication mechanism 26 has been associated with the licensing rights 20, the network device communicates the authentication mechanism 26 to the wireless device or, alternatively, the network device communicates a media content license 28 (i.e., the combined licensing rights and authentication mechanism) to the wireless device.

Once the wireless device 12 receives the authentication mechanism 26 from the network device 14, the licensing module 44 assembles the licensing rights 20 and the authentication mechanism 26 to define a content media license 28.

The optional second network device 32 includes a computer platform 50 that can transmit data across wireless network 16, and that can execute routines and applications. The computer platform 50 includes a media content module 52 operable to interact with content module 30 resident on the wireless device 12. In some aspects, media content module 52 may forward media content module 30 to the wireless device 12 to enable the wireless device to retrieve content from the network device. Further, media content module 52 may forward the media content index 36 and the plurality of licensing parameters 22 to the wireless device 12. The media content index 36 may identify the content 34 available from the network device 32. The plurality of licensing parameters 22 may identify various usage terms, pricing and conditions that may be available for one or more of the plurality of content 34 provided by the network device 32. Further, in response to a request for more information on a specific piece of content, media content module 52 may forward the requested content 18, which may be selected from the plurality of content 34, as well as one or more corresponding licensing codes 38 which identify available ones of the plurality of licensing parameters 22 for the requested content. For example, once the licensing codes 38 have been communicated to the wireless device, the licensing module 44 uses the codes in combination with the licensing parameters to generate licensing right options for the user of the wireless device.

Thus, system 10 provides apparatus and methods for creating a license 20 to selected content 18 at the wireless device 12.

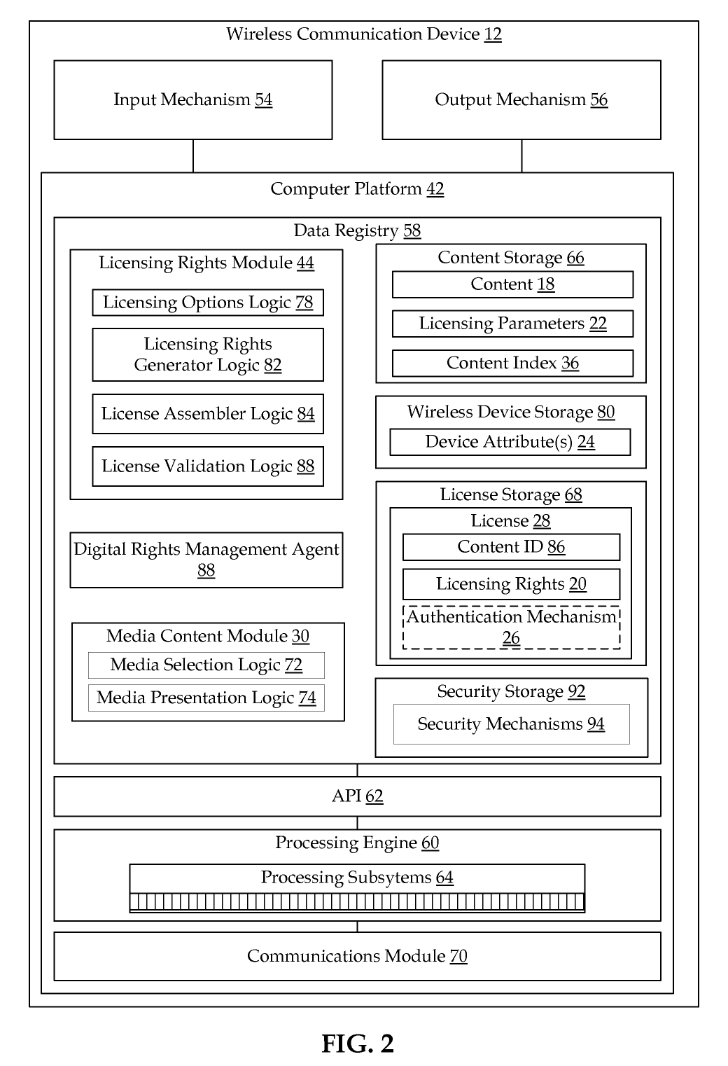

Referring to FIG. 2, according to one aspect, a wireless communication device is depicted. The wireless device 12 may include any type of computerized, wireless device, such as cellular telephone, Personal Digital Assistant (PDA), two-way text pager, portable computer, and even a separate computer platform that has a wireless communications portal, and which also may have a wired connection to a network or the Internet. The wireless device 12 can be a remote-slave, or other device that does not have an end-user thereof but simply communicates data across the wireless network 16, such as remote sensors, diagnostic tools, data relays, and the like. The apparatus and method for creating digitally signed licenses can accordingly be performed on any form of wireless device or computer module, including a wired or wireless communication portal, including without limitation, wireless modems, PCMCIA cards, access terminals, personal computers, telephones, or any combination or sub-combination thereof.

Additionally, wireless device 12 has input mechanism 54 for generating inputs into wireless device, and output mechanism 56 for generating information for consumption by the user of the wireless device. For example, input mechanism 54 may include a mechanism such as a keypad or keyboard, a mouse, a touch-screen display, a microphone in association with a voice recognition module, etc. In certain aspects, the input mechanisms 54 provides for user input to activate the media content module 30, choose a desired piece of content 18 from the media content index 36 and subsequently choose from amongst a wireless-device generated list of usage and pricing options. Further, for example, output mechanism 56 may include a display, an audio speaker, a haptic feedback mechanism, etc. In certain aspects, the output mechanisms assist in providing a user access to the media content index, the usage and pricing options and the media content.

Further, wireless device 12 has computer platform 42 that can transmit data across wireless network 16, and that can receive and execute routines and applications and display data transmitted from network devices 14 and 32, such as a licensing server or a media content server or another computer device connected to wireless network 16. Computer platform 42 includes a data registry 58, which may comprise volatile and nonvolatile memory such as read-only and/or random-access memory (RAM and ROM), EPROM, EEPROM, flash cards, or any memory common to computer platforms. Further, data registry 58 may include one or more flash memory cells, or may be any secondary or tertiary storage device, such as magnetic media, optical media, tape, or soft or hard disk.

Further, computer platform 42 also includes a processing engine 60, which may be an application-specific integrated circuit (“ASIC”), or other chipset, processor, logic circuit, or other data processing device. Processing engine 60 or other processor such as ASIC may execute an application programming interface (“API”) layer 62 that interfaces with any resident programs, such as licensing module 44, in a data registry 58 of the wireless device 12. API 62 is typically a runtime environment executing on the respective wireless device. One such runtime environment is Binary Runtime Environment for Wireless® (BREW®) software developed by Qualcomm, Inc., of San Diego, Calif. Other runtime environments may be utilized that, for example, operate to control the execution of applications on wireless computing devices.

Processing engine 60 includes various processing subsystems 64 embodied in hardware, firmware, software, and combinations thereof, that enable the functionality of wireless device 12 and the operability of the wireless device on wireless network 16. For example, processing subsystems 64 allow for initiating and maintaining communications, and exchanging data, with other networked devices. In one aspect, such as in a cellular telephone, communications processing engine 60 may include one or a combination of processing subsystems 64, such as: sound, non-volatile memory, file system, transmit, receive, searcher, layer 1, layer 2, layer 3, main control, remote procedure, handset, power management, diagnostic, digital signal processor, vocoder, messaging, call manager, Bluetooth® system, Bluetooth® LPOS, position determination, position engine, user interface, sleep, data services, security, authentication, USIM/SIM, voice services, graphics, USB, multimedia such as MPEG, GPRS, etc. For the disclosed aspects, processing subsystems 64 of processing engine 60 may include any subsystem components that interact with applications executing on computer platform 42. For example, processing subsystems 64 may include any subsystem components that receive data reads and data writes from API 62 on behalf of the licensing module 44. Further, locally stored media content 18 and media content licenses 28 that are gathered and then logged in the content storage 66 and license storage 68, respectively, are available from these subsystems 64.

Computer platform 42 may further include a communications module 70 embodied in hardware, firmware, software, and combinations thereof, that enables communications among the various components of the wireless device 12, as well as between the wireless device 12 and the wireless network 16. The communication module 70 may include the requisite hardware, firmware, software and/or combinations thereof for establishing a wireless communication connection, including wireless signal transmit, receive, modulation and demodulation components.

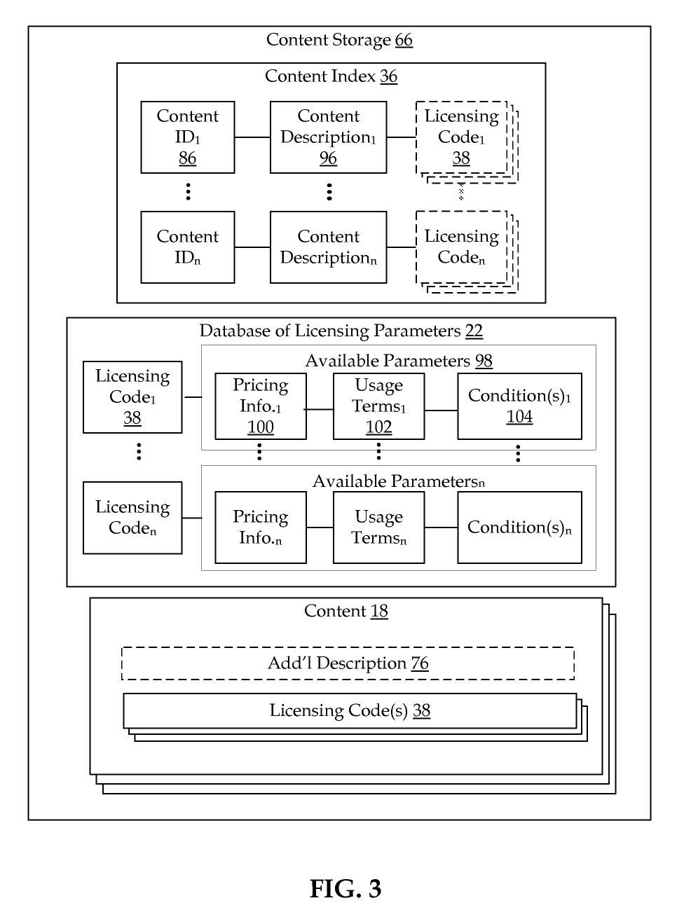

The computer platform 42 may further include a media content module 30 that is launched by the user of the wireless device who wishes to access media content. The media content module 30 includes hardware, software, firmware, executable instructions, data, and combinations thereof which provide the wireless device 12 with the ability to retrieve content descriptions, select parameters to include in proposed licensing rights, obtain a license, retrieve content from across the wireless network 16, and access the retrieved content within the terms of the respective license. In some aspects, media content module 30 includes media selection logic 72, which initiates wireless communication with a media content server in order to determine content available to download. For example, media selection logic 72 may retrieve a media content index 36 from a network device 32, such as a media content server. Alternatively, media selection logic 72 may access a previously-retrieved and/or previously-stored version of the media content index 36 locally residing in content storage 66. Media presentation logic 74 is operable to present the device user with the information from the media content index 36, and is operable to receive selections for requested content 18. For example, these selections may include requests for additional information, and/or requests to acquire the selected content. Further, media selection logic 72 may be operable to forward the request to the network device 32 in order to receive additional description 76 (FIG. 3) relating to the requested content, and/or to receive the requested content 18. As noted above, the time of receipt of requested content 18 may be before, during or after the appropriate license 28 has been obtained. Further, upon receiving a selection and request to acquire media content, media selection logic 72 may be further operable to invoke licensing rights module 44 in order to initiate the acquisition of the appropriate license 28 for the requested content 18.

Licensing rights module 44, which may reside on computer platform 42, is operable to generate proposed licensing rights locally at the wireless device, and communicate the proposed licensing rights to a network device. In response, upon approval of the licensing rights by the network device, licensing rights module 44 receives from the network device 14 either an authentication mechanism 26 associated with the licensing rights 20 or a digitally authenticated media content license 28. Optionally, in some aspects, the licensing rights module 44 assembles the licensing rights 20 and the authentication mechanism 26 into the digitally signed media content license 28. Licensing rights module 44 includes one or any combination of hardware, software, firmware, data and executable instructions to carry out the functionality described herein.

In some aspects, the licensing rights module 44 may include licensing options logic 78 operable for defining licensing terms associated with user-selected media content. In operation, according to some aspects, a user selects media content from the media content index 36, the selection is sent to a network device 32, such as a media content server, and the selected content 18, additional description 76, and/or content licensing codes 38 are communicated back to the wireless device. The licensing options logic 78 may be configured to access the content storage 66, and specifically the database of the plurality of licensing parameters 22 (FIG. 3), to determine one or more sets of available licensing parameters 98, including price, usage terms and conditions. In some aspects, licensing options logic 78 may access wireless device storage 80 to obtain wireless device attributes 24, such as a wireless device identifier (ID) that uniquely identifies the wireless device or the wireless device user, a service status, a current device location, device security capabilities and device hardware capabilities, any combination thereof which may affect the availability of a given set of the plurality of licensing parameters 22. Once the licensing options logic 78 determines the one or more sets of available licensing parameters 98, the parameters representing one or more licensing options are presented to the user for selection.

The licensing rights module 44 also may include licensing rights generator logic 82 operable for generating licensing rights 20 at the wireless device. In some aspects, the licensing rights 20 are defined by the selected ones of the available licensing parameters 98. Once the licensing rights generator logic 82 generates the licensing rights 20, the rights are communicated from the wireless device 12 to a network device 14, such as a licensing server.

The licensing rights module 44 may further include license assembler logic 84. The license assembler logic 84 is invoked if the network device 14 communicates an authentication mechanism 26, as opposed to a digitally signed media content license 28. In the case of such an event, the license assembler logic 84 assembles a media content license 28 including, for example, the licensing rights 20, the corresponding authentication mechanism 26, and the corresponding content identification 86, such as content metadata. Once the license assembler logic 84 has assembled the media content license 28, the license 28 may be stored in license storage 68.

The licensing rights module 44 may further include license validation logic 88 that is implemented in aspects in which the license 28 requires validation prior to accessing the media content 18 associated with the respective license 28. In such aspects, the license validation logic 88 is operable to invoke the digital rights management (“DRM”) agent 90 to access the media content license 28 prior to accessing the related media content 18. The DRM agent 90 interacts with both licensing rights module 44 and media player module 30 to verify the existence of proper licensing rights, such as license 28 in license storage 68, prior to executing media content 18. DRM agent 90 may be embodied in at least one of hardware, software, firmware, data and executable instructions, and generally controls the consumption of any content 18 based on the associated licensing rights 20.

In some aspects, validation of the media content license 28 provides for validating the authentication mechanism 26, which in some aspects includes accessing security storage 92 to retrieve and implement the appropriate one of a plurality of security mechanisms 94, such as a key corresponding to the key used to create the digital signature, a keyed hash function, etc.

Further, in certain aspects, the network device 14 and/or 32 will communicate all or portions of the license 28, the authentication mechanism 26, and/or the content 18, to the wireless device 12 in a secure manner, such as by encrypting and authenticating the data. This authentication is above and beyond the “built-in” authentication that comes from digitally signing or applying a keyed-hash message authentication code (HMAC) to the license itself. It protects the entire communications channel, so that associated metadata, etc. cannot be tampered with or viewed. In such cases, the wireless device 12 may utilize one of a plurality of security mechanisms 94, such as a corresponding key or the like, which may be stored in the security storage 92, to decrypt and authenticate the secured message and thereby allow access to or modification of the information. In other aspects, another one of the plurality of security mechanisms 94 may include a locking mechanism, such as a key or the like, for encrypting or otherwise encoding the proposed licensing rights 20, or any other information, prior to communication to the network device 14 or prior to internally storing information.

In any case, once the license 28 has been validated, the licensing rights module 44 causes enforcement the rights granted by the license and provides the user with access to the media content 18 according to the terms of the license.

Referring additionally to FIG. 3, the content storage 66 of wireless device 12 may store media content index 36 that provides the user with one or a plurality of content identifications (IDs) 86, such as a name and/or unique identifier, and corresponding descriptions 96 of the content available from network device 32. Additionally, content index 36 may further include one or more licensing code(s) 38 associated with each content ID 86. Each licensing code 38 relates to a predetermined set of available parameters 98 within the plurality of licensing parameters 22 for the given content ID 86. For example, in some aspects, the predetermined available licensing parameters 98 may include one or more of: pricing information 100, which identifies a cost associated with the given set of licensing terms, such as a monetary amount or a discount or mark-up from a standard cost; usage terms 102, which identify usage rules for the content, such as a predetermined number of times the content may be accessed, a predetermined time period for which the content may be accessed, unlimited access, etc.; and one or more conditions 104, which may identify a prerequisite for qualifying for the given pricing information 100 and/or usage terms 102, such as a device attribute 24, a network attribute, a device user attribute, and any other quality that may affect pricing and usage. Examples of conditions 104 include, but are not limited to: a predetermined status, such as a membership status, an association with an entity/enterprise, a carrier relationship, a content provider relationship, a content distributor relationship, etc.; a predetermined device hardware characteristic, such as an amount of memory, a processor speed, a display size and configuration, a sound speaker type and capability, etc.; a predetermined device software characteristic, such as a version of an application, program or operating system; a predetermined device user characteristic, such as a user identification; and, a predetermined network-related characteristic, such as an associated carrier network or network component, etc. Further, the content storage 66 includes one or more selected content 18. Each selected content 18 may further include additional content description 76, which may provide a more detailed explanation of the respective content. Further, each selected content 18 may further include references to one or more licensing codes 38 corresponding to available licensing parameters 98 for the respective content.

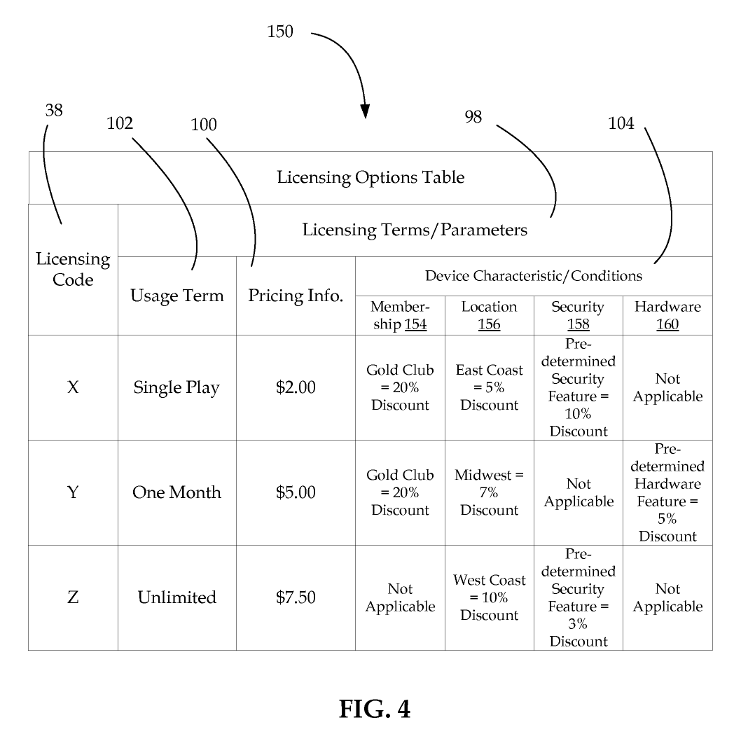

Referring to FIG. 4, in some aspects, a licensing options table 150 may be presented on the output mechanism 56 of the wireless device 10 upon indicating a desire to obtain rights to desired content, such as by making a selection from content index 36. Such a table 150 interactively provides the user of the wireless device 12 with the ability to select from among a plurality of available licensing terms/parameters 98 associated with the selected content 18 (FIG. 3) or content ID 86 (FIG. 3), and to thereby selectively generate proposed licensing rights 20 (FIG. 2). As noted above, each of the plurality of media content 34 (FIG. 1) is associated with one or more licensing codes 38. Further, each licensing code 38 is indexed in a list of licensing parameters 22. As such, upon selected of a given piece of content 18, the media content module 30 references the list of licensing parameters 22 and extracts the one or more available licensing parameter terms 98 corresponding to each licensing code 38 associated with the selected content 18. Thus, in this manner, media content module 30 generates the licensing options table 150 and initiates presentation of the table to the user of the wireless device 12. In the illustrated example, licensing terms 98 include usage terms 102, pricing information 100 and device characteristics/conditions 104. It is noted that the illustrated table shows only an example of licensing terms; alternate aspects may include other licensing terms. In the illustrated table, for example, the user is presented with three different licensing codes, “X”, “Y” and “Z”, which allow the user to choose from three different usage and pricing options. For example, licensing code “X” is associated with a single play usage option at a price of $2.00, licensing code “Y” is associated with a monthly usage option at a price of $5.00 and licensing code “Z” is associated with an unlimited usage option at a price of $7.50.

In some aspects, the device characteristics/conditions 104 define characteristics or conditions that affect the availability of the given licensing terms and/or that provide for a predetermined adjustment to the given pricing information and/or the given usage terms. For example, in the illustrated table 150, the device characteristics/conditions 104 include the membership status 154 of the user, the location 156 of the device or the user, the security capabilities 158 of the device and the hardware 160 capabilities of the device. Thus, in the illustrated aspect, a 20% pricing discount will be afforded the user if a membership exists, a 5% pricing discount will be afforded the user if the device is located in a predefined location, a 10% pricing discount will be afforded the user if the device is equipped with requisite security capabilities and a 5% pricing discount will be afforded the user if the device is equipped with requisite hardware capabilities. Although illustrated as affecting pricing information 100, it should be re-emphasized that the device characteristics/conditions 104 may affect the pricing information 100, the usage terms 102, any combination thereof, and even the ability to qualify for the licensing option. Additionally, in some aspects, for example, the media content module 30 may automatically highlight or otherwise indicate the ability to qualify for a given one of the device characteristics/conditions 104 based on comparing the device attributes 24 (FIG. 2) with the device characteristics/conditions 104.

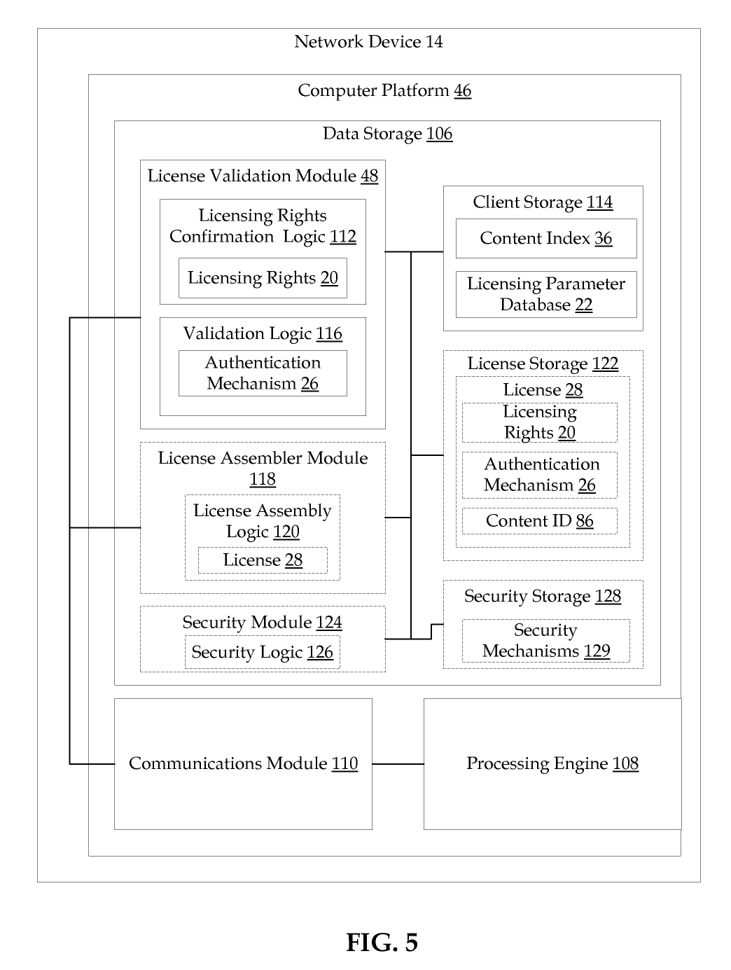

Referring to FIG. 5, in one aspect, illustrates a network device 14, such as a licensing server is presented. The network device may comprise at least one of any type of hardware, server, personal computer, mini computer, mainframe computer, or any computing device either special purpose or general computing device. Further, the modules and applications described herein as being operated on or executed by the network device 14 may be executed entirely on the network device 14 or alternatively, in other aspects, separate servers or computer devices may work in concert to provide data in usable formats to parties, and/or to provide a separate layer of control in the data flow between the wireless device 12 and the modules and applications executed by network device 14.

The network device 14 has computer platform 46 that can transmit and receive data across wireless network 16, and that can execute routines and applications. Computer platform 46 includes a data storage 106, which may comprise volatile and nonvolatile memory such as read-only and/or random-access memory (RAM and ROM), EPROM, EEPROM, flash cards, or any memory common to computer platforms. Further, data storage 106 may include one or more flash memory cells, or may be any secondary or tertiary storage device, such as magnetic media, optical media, tape, or soft or hard disk. Further, computer platform 46 also includes a processing engine 108, which may be an application-specific integrated circuit (“ASIC”), or other chipset, processor, logic circuit, or other data processing device. The computer platform 46 may further include a communications module 110 embodied in hardware, firmware, software, and combinations thereof, that enables communications among the various components of the network device 14, as well as between the network device 14 and the wireless network 16. For example, in the described aspects, the communication module 110 is configured to receive proposed licensing rights 20 from wireless device 12 and, if agreeable, communicate in response an authentication mechanism 26 and/or an authenticated license 28 that provides access to the respective content 18 (FIG. 1). As noted above, authentication mechanism 26 may include a digital signature or any other mechanism operable to authenticate licensing approval-related information from the network device 14.

The data storage 106 includes a license validation module 48 that is in communication with the processing engine 108 and operable for validating the proposed licensing rights 20 and generating an authentication mechanism, such as a digital signature, digital certificate, keyed hash or the like, in response to validation of the licensing rights 20.

The license validation module 48 includes rights confirmation logic 112 that confirms that the licensing rights 20 proposed by the wireless device 12 falls within the scope of available licensing parameters 98 for the given content 18 and/or for the given wireless device 12. For example, the rights confirmation logic 112 may compare the proposed licensing rights 20 with the authentic version of available licensing parameters 98 and the licensing codes 38 associated with the given content 18 and/or content ID 86 (FIG. 3), such as by confirming this information with network device 32 and/or with a local copy of this information stored in client storage 114.

The license validation module 48 further includes validation logic 116, which is implemented if the terms of the licensing rights 20 are approved/confirmed. The validation logic 116 is operable to cause the generation of an authentication mechanism 26, such as a digital signature, digital certificate or the like, to validate the licensing rights 20. Further, for example, authentication mechanism 26 may further include an acceptable encryption algorithm, a cipher, a keyed hash, a message authentication code (MAC), etc.

In some aspects, the communications module 110 of the network device 14 will communicate the generated authentication mechanism 26 to the wireless device 12, while in alternate embodiments the network device will assemble a license 28 including the authentication mechanism 26 and communicate the assembled license to the wireless device 10. Thus, in those aspects in which the license 28 is assembled at the network device 14, the data storage 106 includes a license assembler module 118 that implements license assembly logic 120 operable for assembling a media content license 28. The license assembler logic 120 assembles a media content license 28 including the licensing rights 20, authentication mechanism 26, and content identification 86, such as content metadata or the like. In some aspects, the network device 14 may include license storage 122 that provides for storage of the license 28. Additionally, the license 28 and/or authentication mechanism 26 may be generated and/or stored with reference to the respective selected content 18 and/or content ID 86, as well as with reference to the identification information associated with the respective wireless device 12.

In some aspects, the network device 14 may assign and communicate one of a plurality of security mechanisms 129 along with the authentication mechanism 26. In this case, the data storage 106 may include a security module 124 having security logic 126 operable for generating and/or assigning one of the security mechanisms 129, which may be stored in security storage 128. The security mechanisms 129 may include encryption and/or decryption mechanisms, such as one of a public/private key pair, a symmetric key or any other mechanism that provides for the secure exchange of the authentication mechanism 26 and/or license 28 between the network device 14 and wireless device 12.

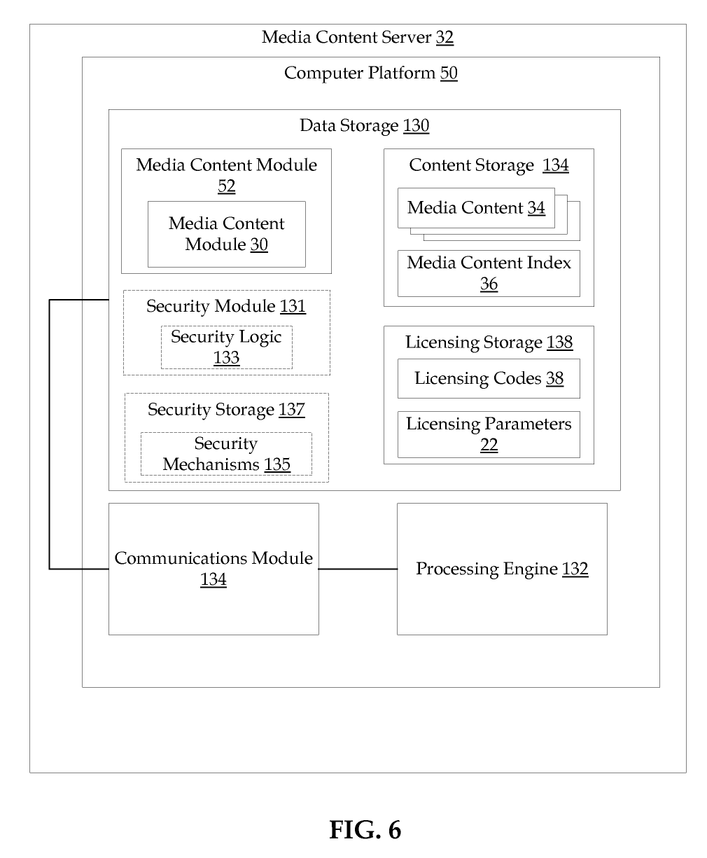

Referring to FIG. 6, some aspects of the described embodiments include a second network device 32, such as a media content server or the like. As previously discussed, the functionality of the media content server 32 and the licensing server 14 may be incorporated in one comprehensive network device/component or in individual network devices/components. The second network device 32 may comprise at least one of any type of hardware, server, personal computer, mini computer, mainframe computer, or any computing device either special purpose or general computing device. Further, the modules and applications described herein as being operated on or executed by the second network device 32 may be executed entirely on the second network device 32 or alternatively, in other aspects, separate servers or computer devices may work in concert to provide data in usable formats to parties, and/or to provide a separate layer of control in the data flow between the wireless device 12 and the modules and applications executed by second network device 32.

The second network device 32 has computer platform 50 that can transmit and receive data across wireless network 16, and that can execute routines and applications. Computer platform 50 includes a data storage 130, which may comprise volatile and nonvolatile memory such as read-only and/or random-access memory (RAM and ROM), EPROM, EEPROM, flash cards, or any memory common to computer platforms. Further, data storage 130 may include one or more flash memory cells, or may be any secondary or tertiary storage device, such as magnetic media, optical media, tape, or soft or hard disk. Further, computer platform 50 also includes a processing engine 132, which may be an application-specific integrated circuit (“ASIC”), or other chipset, processor, logic circuit, or other data processing device. The computer platform 50 may further include a communications module 134 embodied in hardware, firmware, software, and combinations thereof, that enables communications among the various components of the second network device 32, as well as between the second network device 32 and the wireless network 16. For example, in the described aspects, the communication module 134 is configured to receive messages representing requests for available media content, additional content information, and selected media content, and to transmit the content index 36, the licensing parameter database 22, and any selected content 18 from the plurality of available media content 34.

The data storage 130 includes media content module 52 that is operable to interact with the media content module 30 resident on the wireless device 12. In some aspects, media content module 52 may forward media content module 30 to the wireless device 12 to enable the wireless device to retrieve content from the network device 32. Further, media content module 52 may be operable to access content storage 130 and retrieve the media content index 36 and forward the index to the wireless device 12. The media content index 36 may identify the content available from the network device 32. Additionally, the media content module 52 may be operable to access the licensing storage 138, retrieve the database of licensing parameters 22, and forward the database of licensing parameters 22 to the wireless device 12. As previously noted, the database of licensing parameters 22 may identify a plurality of licensing terms and conditions, predetermined combinations of which are available for one or more of the plurality of content 34 provided by the network device 32. Further, in response to a request from the wireless device 12 for more information on a specific piece of content, media content module 52 may access content storage 134 to retrieve and forward additional description 76 (FIG. 3) associated with the requested content 18 (FIG. 3), which may be selected from the plurality of content 34. Further, media content module 52 is operable to transmit to the wireless device 12 the desired content 18 (FIG. 3) selected from the plurality of content 34, which as noted previously may occur at any time during the interaction between the wireless device 12 and one and/or both of servers 32 and 14.

Thus, the content index 36 and database of licensing parameters 22 may be utilized by network device 32 to provide an efficient system of identifying available content and corresponding available licensing options. The data held by both the index 36 and the licensing parameter database 22 may be dynamically updated to include references to new content and/or new licensing parameters, or to delete inactive content and/or parameters. Therefore, the content index 36 and database of licensing parameters 22 provide a dynamic mechanism for establishing a plurality of licensing options for a plurality of content.

Additionally, in some aspects, data storage 130 may further include a security module 131 having security logic 133 operable to apply one of a plurality of security mechanisms 135 to any information transmitted and/or received by media content server 32. For example, data storage 130 may include a security storage 137 for storing the plurality of security mechanism 135. The security mechanisms 135 may include, for example, one or any combination of mechanisms for encrypting and/or decrypting information, such as a public/private key, a symmetric key, etc. For example, all or any portion of one or more of the plurality of media content 34 may be encrypted by one of the security mechanisms 135, in this case a locking mechanism, to protect against unauthorized usage. For example, referring to FIG. 3, the selected content 18 may be transmitted to the wireless device 12 in a state wherein the additional description 76 is in the clear, but the remaining portion of the selected content 18 is encrypted. As such, the wireless device 12 may be prevented from accessing the entirety of the selected content 18 until appropriate licensing rights, such a license 28 (FIG. 1) are obtained, and in some cases, until appropriate fees have been paid. Network device 14 may notify network device 32 when it is appropriate to send a given wireless device 12 the access mechanism, i.e. one of the plurality of security mechanism 135, corresponding to the locking mechanism used to secure the selected content 18. In other alternatives, network device 32 may provide the access mechanism to network device 14, which may then forward it to the wireless device 12 along with the authentication mechanism 26 and/or the license 28.

Referring back to FIG. 1, the wireless network 16 may include at least one, or any combination, of: a cellular telephone network; a terrestrial telephone network; a satellite telephone network; an infrared network such as an Infrared Data Association (“IrDA”)-based network; a short-range wireless network; a Bluetooth® technology network; a ZigBee® protocol network; an ultra wide band (“UWB”) protocol network; a home radio frequency (“HomeRF”) network; a shared wireless access protocol (“SWAP”) network; a wideband network, such as a wireless Ethernet compatibility alliance (“WECA”) network, a wireless fidelity alliance (“Wi-Fi Alliance”) network, and a 802.11 network; a public switched telephone network; a public heterogeneous communications network, such as the Internet; a private communications network; and land mobile radio network. Suitable examples of telephone networks include at least one, or any combination, of analog and digital networks/technologies, such as: code division multiple access (“CDMA”), wideband code division multiple access (“WCDMA”), universal mobile telecommunications system (“UMTS”), advanced mobile phone service (“AMPS”), time division multiple access (“TDMA”), frequency division multiple access (“FDMA”), orthogonal frequency division multiple access (“OFDMA”), global system for mobile communications (“GSM”), single carrier (“1X”) radio transmission technology (“RTT”), evolution data only (“EV-DO”) technology, general packet radio service (“GPRS”), enhanced data GSM environment (“EDGE”), high speed downlink data packet access (“HSPDA”), analog and digital satellite systems, and any other technologies/protocols that may be used in at least one of a wireless communications network and a data communications network.

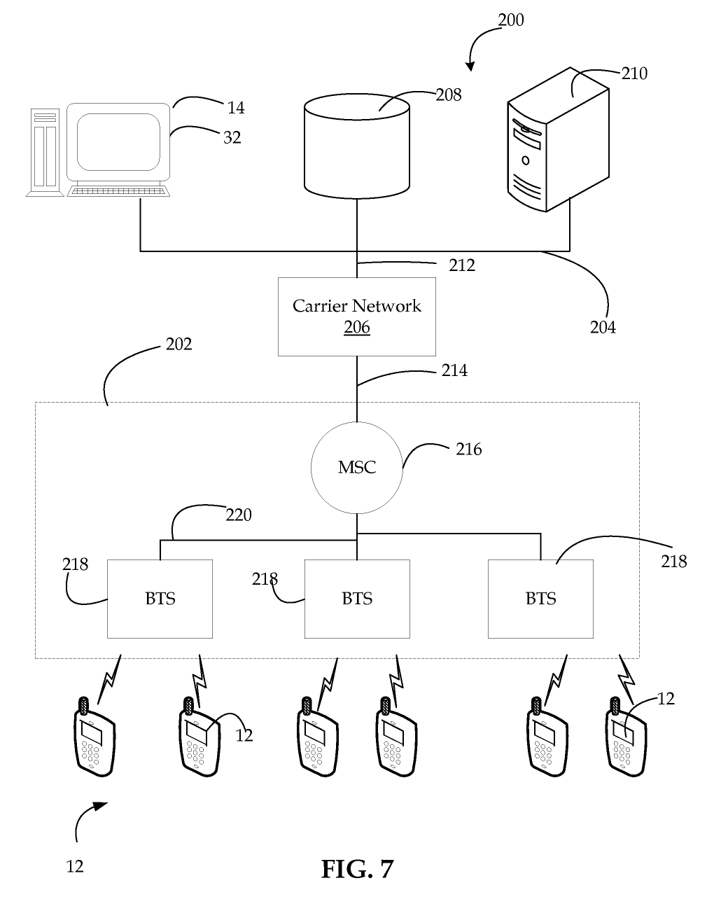

Referring to FIG. 7, in one aspect, each of the plurality of wireless devices 12 comprises a cellular telephone. A cellular telephone system 200 may include wireless network 202 connected to a wired network 204 via a carrier network 206. Wireless devices 12 are being manufactured with increased computing capabilities and often can communicate packets including voice and data over wireless network 202. As described earlier, these “smart” wireless devices 12 have APIs resident on their local computer platform 42 that allow software developers to create software applications that operate on the cellular telephone 12, and control certain functionality on the device. FIG. 7 is a representative diagram that more fully illustrates the components of a cellular wireless network and the interrelation of the elements of one aspect of the present system. Cellular wireless network 202 is merely exemplary and can include any system whereby remote modules, such as wireless devices 12 communicate over-the-air between and among each other and/or between and among components of a wireless network 202, including, without limitation, wireless network carriers and/or servers.

In system 200, licensing server 14 and/or media content server 32 can be in communication over a wired network 204 (e.g. a local area network, LAN) with a separate data repository 208 for storing modules and/or data associated with the described embodiments, such as the licensing rights module, the licenses, the content or wireless device data. Further, a data management server 210 may be in communication with licensing server 14 and/or media content server 32 to provide post-processing capabilities, data flow control, etc. Licensing server 14 and/or media content server 32, data repository 208 and data management server 210 may be present on the cellular telephone system 200 with any other network components that are needed to provide cellular telecommunication services. Licensing server 14 and/or media content server 32, and/or data management server 208 communicate with carrier network 206 through a data links 212 and 214, which may be data links such as the Internet, a secure LAN, WAN, or other network. Carrier network 206 controls messages (generally being data packets) sent to a mobile switching center (“MSC”) 216. Further, carrier network 206 communicates with MSC 216 by a network 214, such as the Internet, and/or POTS (“plain old telephone service”). Typically, in network 214, a network or Internet portion transfers data, and the POTS portion transfers voice information. MSC 216 may be connected to multiple base stations (“BTS”) 218 by another network 220, such as a data network and/or Internet portion for data transfer and a POTS portion for voice information. BTS 218 ultimately broadcasts messages wirelessly to the wireless devices, such as wireless devices 10, by short messaging service (“SMS”), or other over-the-air methods.

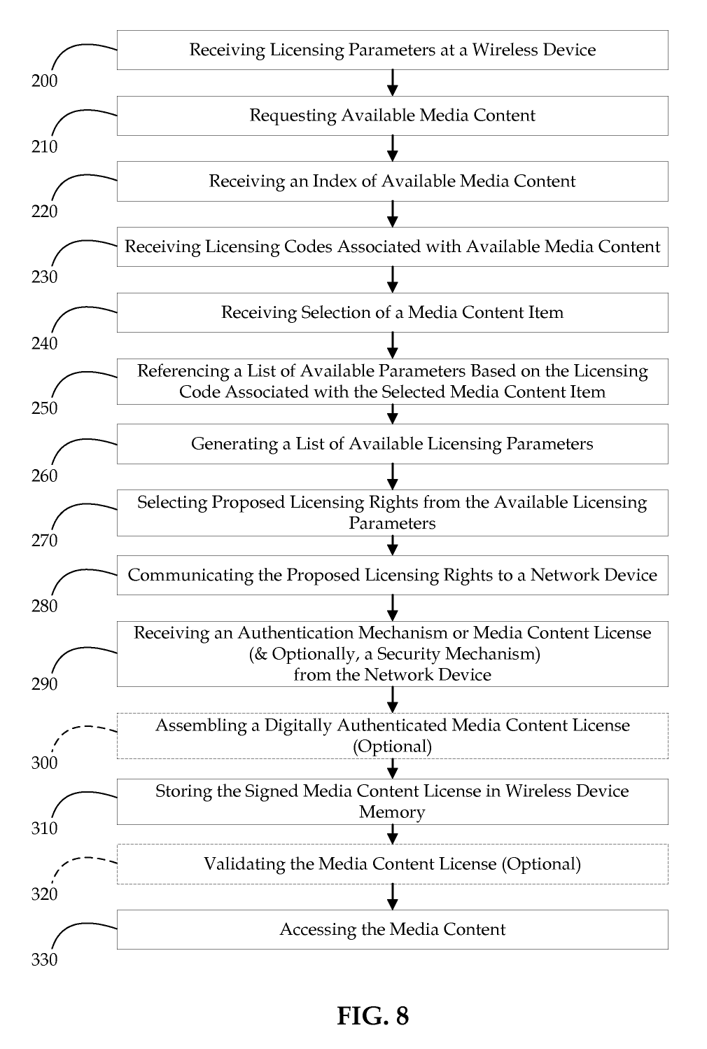

In accordance with an aspect, FIG. 8 provides a flow diagram of a method for generating licensing rights at a wireless device. At Event 200, license parameters are received or otherwise loaded onto a wireless device. In this regard, the licensing parameters may be communicated from a network device, such as a licensing server, a media content server or the like. Alternatively, the licensing parameters may be preloaded on the wireless device by the device manufacturer or service provider or the licensing parameters loaded on to the wireless device by any other acceptable means. In the illustrated method the licensing parameters are received or otherwise loaded prior to requesting access to media content, however; the licensing parameters may received or otherwise loaded onto the wireless device at any point in time during the process of generating the media content license or accessing the media content.

Licensing parameters may include but are not limited to pricing information, which identifies a cost associated with the given set of licensing terms, such as a monetary amount or a discount or mark-up from a standard cost; usage terms, which identify usage rules for the content, such as a predetermined number of times the content may be accessed, a predetermined time period for which the content may be accessed, unlimited access, etc and conditions, which may identify a prerequisite for qualifying for the given pricing information and/or usage terms. Conditions may include a device attribute, a network attribute, a device user attribute, and any other quality that may affect pricing and usage. Examples of conditions include, but are not limited to: a predetermined status, such as a membership status, an association with an entity/enterprise, a carrier relationship, a content provider relationship, a content distributor relationship, etc.; a predetermined device hardware characteristic, such as an amount of memory, a processor speed, a display size and configuration, a sound speaker type and capability, etc.; a predetermined device software characteristic, such as a version of an application, program or operating system; a predetermined device user characteristic, such as a user identification; and, a predetermined network-related characteristic, such as an associated carrier network or network component, etc.

At Event 210, a request is generated for available media content. In many aspects, the request for available media content will include launching a media player module or application, which in turn communicates with an external network, such as the Internet, to retrieve a listing of available media content. At Event 220, in response to the request for available media content, the wireless device will receive an index of available media content communicated from a network device, such as a media content server. In certain aspects, the content index will include the title or name of the media content, a brief description of the content and, optionally, an unprotected preview portion of the media content (i.e., an audio, video or multimedia preview of the media content). The media content index is provided to the user through an appropriate output mechanism, such as a display.

At Event 230, the wireless device receives licensing codes associated with the available media content. The licensing codes may be communicated as part of the index of available content (Event 220) or the licensing codes may be communicated in conjunction with a request for additional information related to an available media content item, or upon selection of a media content item or at any other appropriate point in time during the generation of the media content license or the accessing of media content. The licensing code is indexed in the listing of licensing parameters and provides for the media content item to be associated with one or more licensing parameters.

At Event 240, the wireless device receives a user selection of desired media content. In the aspect described above, the selection may occur by a user indicating a choice of a desired media content item, such as an audio file, video file, multimedia file, text file or the like, from a media content index listing of available media content items. Selection of an option to use or purchase rights to the selected media content item triggers, at Event 250, the referencing of a list of available parameters based on the licensing code associated with the selected media content item. At Event 260, a selection list of available licensing parameters is generated and displayed on a wireless device output mechanism, such as a display. At Event 270, if the user desires a license to use the media content, the wireless device receives a user selection from one or a plurality of the available licensing parameters to form proposed licensing rights.

At Event 280, the proposed licensing rights and a content identifier, such as appropriate content metadata, are communicated to a network device, such as a licensing server. At Event 290, in response to the communication of the proposed licensing rights to the network device, the wireless device receives an authentication mechanism or, alternately, a media content license that includes the licensing rights, the authentication mechanism and a content identifier. The authentication mechanism may include a digital signature, a digital certificate, a keyed hash value or the like. Additionally, the wireless device may receive a security mechanism such as a decryption key, which is used to access the selected content. At optional Event 300, the wireless device assembles the media content license, including the licensing rights, the authentication mechanism, the content identifier and, optionally, the security mechanism. The assembling of the media content license at the wireless device is only required if the network device communicates the authentication mechanism absent an assembled media content license.

At Event 310, the wireless device stores the digitally authenticated media content license in wireless device memory. When a user desires access to the media content, at optional Event 320, the media content license is validated based on the authentication mechanism. Once validated, the licensing rights are enforced, secured content may be unsecured, and, at Event 330, the user is granted access to the media content according to the rights in the media content license.

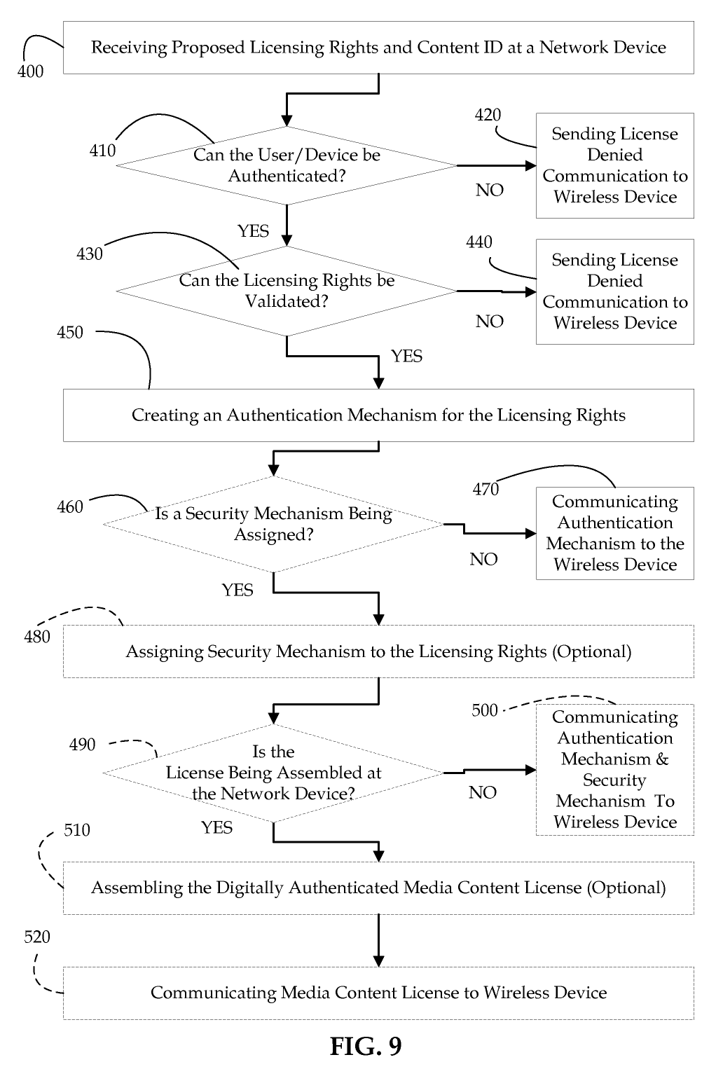

In accordance with another aspect, FIG. 9 provides a flow diagram of a method for validating licensing rights and generating an authentication mechanism at a network device. At Event 400, a network device, such as a licensing server receives proposed licensing rights and a content identifier from a wireless device. At Decision 410, the network device determines if the wireless device or, alternately the user of the wireless device, can be authenticated. If the wireless device cannot be authenticated, at Event 420, the network device communicates a license denied message to the wireless device. If the wireless device and/or user can be authenticated then, at Decision 430, the network device determines if the licensing rights can be validated as acceptable licensing rights for the selected content. Validation occurs by matching up the proposed licensing rights with confirmed, allowable licensing rights. The network device may store or otherwise have access to the confirmed, allowable licensing rights, such as via an authentic listing of licensing parameters and/or licensing codes. If a determination is made that the licensing rights cannot be authenticated then, at Event 440, the network device communicates a license denied message to the wireless device. If the licensing rights can be validated then, at Event 450, the network device creates an authentication mechanism, such as a digital signature, digital certificate, keyed hash value or the like with respect to the licensing rights. For example, in one aspect, the network device executes a standard RSA algorithm over a hash of the license that then serves as the digital signature.

Once the authentication mechanism has been generated, at Decision 460, the network device may optionally determine if a security mechanism has been or is to be assigned to the content and/or the authentication mechanism and/or license. If no security mechanism is warranted, then at Event 470, the network device communicates the authentication mechanism to the wireless device that sent the proposed licensing rights. If a determination is made that a security mechanism is to be assigned, then at Event 480, a security mechanism is assigned to the content and/or authentication mechanism and/or license. At Decision 490, the network device determines if a media content license is to be assembled at the network device. If a determination is made that the network device does not assemble the media content license then, at Event 500, the network device communicates the authentication mechanism and the security mechanism to the wireless device.

If a determination is made that the network device assembles a license, then at optional Event 510, the media content license is assembled including the licensing rights, the authentication mechanism, a content identifier and, optionally, a security mechanism. At Event 520, the assembled media content license is communicated to the wireless device.

Thus, the described aspects provide apparatus and methods for generating media content licenses in a wireless network environment. The disclosed aspects provide for systems that bifurcates license formation by generating the licensing rights at the wireless device and generating the associated authentication mechanism at a network device. As such, the proposed aspects provide for content media licenses that are highly secured and are not readily susceptible to alteration or attack.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

Therefore, upon having the benefit of the teachings presented in the foregoing descriptions and the associated drawings, many modifications and other embodiments of the invention will come to mind to one skilled in the art to which this invention pertains. Therefore, it is to be understood that the invention is not to be limited to the specific aspects disclosed and that modifications are intended to be included within the scope of the appended claims.

What is claimed is:

1. A method for generating a media content license, comprising:
generating, at a wireless device, one or more proposed licensing rights related to selected media content;
communicating the proposed licensing rights to a network device; and
receiving, at the wireless device, licensing rights validation thereby defining authenticated licensing rights.

2. The method of claim 1, wherein generating, at a wireless device, one or more proposed licensing rights related to selected media content further comprises:
generating a list of one or more available licensing parameters associated with the selected media content; and
selecting one or more available licensing parameters to define the one or more proposed licensing rights.

3. The method of claim 2, wherein generating a list of one more available licensing parameters associated with the selected media content further defines the one or more licensing parameters as chosen from the group consisting of a usage term, a price and a wireless device condition.

4. The method of claim 3, wherein the wireless device condition is further defined as chosen from the group consisting of service status, device location, security capability and hardware capability.

5. The method of claim 2, wherein generating a list of available licensing parameters associated with the selected media content further comprises referencing a licensing code associated with the selected media content to define available licensing parameters.

6. The method of claim 5, wherein referencing a licensing code associated with the selected media content to define available licensing parameters further comprises receiving the licensing code in response to an inquiry for available media content.

7. The method of claim 5, wherein referencing a licensing code associated with the selected media content to define available licensing parameters further comprises receiving the licensing code in response to an inquiry for information related to a selected media content item.

8. The method of claim 1, wherein receiving, at the wireless device, licensing rights validation thereby defining authenticated licensing rights further comprises receiving an authentication mechanism.

9. The method of claim 8, further comprising associating the authentication mechanism with the licensing rights.

10. The method of claim 9, further comprising assembling the authentication mechanism, the licensing rights and a content identifier to form a media content license.

11. The method of claim 10, wherein assembling the authentication mechanism, the licensing rights and a content identifier to form a media content license further comprises assembling the authentication mechanism, the licensing rights, a content identifier and a security mechanism to form the media content license.

12. The method of claim 1, wherein receiving, at the wireless device, licensing rights validation thereby defining authenticated licensing rights further comprises receiving a media content license that includes the licensing rights, an authentication mechanism and a content identifier.

13. The method of claim 12, wherein receiving a media content license that includes the licensing rights, an authentication mechanism and a content identifier further comprises receiving a media content license that includes the licensing rights, an authentication mechanism, a content identifier and a security mechanism.

14. A machine-readable medium comprising instructions, which, when executed by a machine, cause the machine to perform operations, comprising:
instructions to generate, at a wireless device, one or more proposed licensing rights related to selected media content;
instructions to communicate the proposed licensing rights to a network device; and
instructions to receive, at the wireless device, licensing rights approval thereby defining authenticated licensing rights.

15. The machine-readable medium of claim 14, further comprising instructions to receive an authentication mechanism and associate the authentication mechanism with the licensing rights, and instructions to assemble the licensing rights, the authentication mechanism and a content identifier to define a media content license.

16. At least one processor device, implemented in a wireless device, configured to perform the operations of:
generating one or more proposed licensing rights related to selected media content;
communicating the proposed licensing rights to a network device; and
receiving licensing rights approval thereby defining authenticated licensing rights.

17. The processor device of claim 16, wherein the processor is further configured to perform the operation of receiving an authentication mechanism, associating the authentication mechanism with the licensing rights and assembling the licensing rights, the authentication mechanism and a content identifier to define a media content license.

18. A wireless communication device comprising:
a computer platform including a processing engine and a memory unit; and
a licensing rights module stored in the memory unit and executed by the processing engine, wherein the licensing module is operable to present licensing options for selected media content, generate proposed licensing rights based on selected licensing options and communicate the proposed licensing rights to a network device for validation.

19. The device of claim 18, wherein the licensing rights module that is operable to present licensing options for selected media content is further operable to generate a list of one or more available licensing parameters associated with the selected media content and provide for the selection of one or more available licensing parameters to define the one or more proposed licensing rights.

20. The device of claim 19, wherein the licensing rights module that is operable to generate a list of one or more available licensing parameters associated with the selected media content further defines the one or more licensing parameters as chosen from the group consisting of a usage term, a price and a wireless device condition.

21. The device of claim 20, wherein the wireless device condition is further defined as chosen from the group consisting of service status, device location, security capability and hardware capability.

22. The device of claim 19, wherein the licensing rights module that is operable to wherein generate a list of one or more available licensing parameters associated with the selected media content is further operable to reference a licensing code associated with the selected media content to define available licensing parameters.

23. The device of claim 22, wherein the licensing rights module that is operable to reference a licensing code associated with the selected media content to define available licensing parameters is further operable to receive the licensing code in response to an inquiry for available media content.

24. The device of claim 22, wherein the licensing rights module that is operable to reference a licensing code associated with the selected media content to define available licensing parameters is further operable to receive the licensing code in response to an inquiry for information related to a selected media content item.

25. The device of claim 18, wherein the licensing rights module is further operable to receive a licensing validation from the network device.

26. The device of claim 25, wherein the licensing rights module that is operable to receive a licensing validation from the network device further defines the licensing validation as an authentication mechanism.

27. The device of claim 26, wherein the licensing rights module is further operable to associate the authentication mechanism with the licensing rights.

28. The device of claim 25, wherein the licensing rights module is further operable to assemble the licensing rights, the authentication mechanism and a content identifier to form a content media license.

29. The device of claim 18, wherein the licensing rights module is further operable to receive, upon validation of the proposed licensing rights, a media content license that includes the licensing rights, an authentication mechanism and a content identifier.

30. A wireless communication device, the device comprising:
means for processing data on the wireless device;
means for storing data on the wireless device that is in communication with the means for processing data;
means for presenting licensing options for selected media content;
means for generating proposed licensing rights based on selected licensing options; and
means for communicating the proposed licensing rights to a network device for validation.

31. A system for creating digitally authenticated licenses in a wireless network, the system comprising:
a wireless communication device comprising a computer platform that includes a processing engine, a memory unit and a licensing rights module that is stored in the memory unit and executed locally by the processing engine, wherein licensing rights module is operable to present licensing options for selected media content, generate proposed licensing rights based on selected licensing options and communicate the proposed licensing rights; and
a network device in communication with the wireless device that comprises a computer platform that includes a processing engine, a memory unit and a license validation module stored in the memory unit and executed by the processing engine, wherein the license validation module is operable to validate proposed licensing rights received from the wireless communication device and communicate a licensing rights validation to the wireless communication device.

32. The system of claim 31, wherein the licensing validation module that is operable to communicate a licensing rights validation to the wireless communication device further defines the licensing rights validation as an authentication mechanism.

33. The system of claim 32, wherein the licensing rights module is further operable to assemble the authentication mechanism, the licensing rights and a content identifier to form a content media license.

34. The system of claim 31, wherein the licensing validation module that is operable to communicate a licensing rights validation to the wireless communication device further defines the licensing rights validation as a content media license that includes the licensing rights, an authentication mechanism and a content identifier.

35. A method for validating licensing rights within a wireless network, the method comprising the steps of:
receiving, at a network device, communication from a wireless device that includes proposed licensing rights associated with media content;
validating, at the network device, the proposed licensing rights; and
communicating, to the wireless device, a licensing rights validation thereby defining authenticated licensing rights.

36. The method of claim 35, further comprising generating an authentication mechanism upon validation of the proposed licensing rights.

37. The method of claim 36, wherein communicating, to the wireless device, a licensing rights validation thereby defining authenticated licensing rights further comprises communicating, to the wireless device the authentication mechanism.

38. The method of claim 35, further comprising assembling the licensing rights, the authentication mechanism and a content identifier to form a content media license.

39. The method of claim 38, wherein communicating, to the wireless device, a licensing rights validation thereby defining authenticated licensing rights further comprises communicating, to the wireless device, the content media license.

40. The method of claim 35, further comprising generating a security mechanism associated with the licensing rights validation and communicating, to the wireless device, the security mechanism

41. A machine-readable medium comprising instructions, which, when executed by a machine, cause the machine to perform operations, comprising:
instructions to receive, at a network device, communication from a wireless device that includes proposed licensing rights associated with media content;
instructions to validate, at the network device, the proposed licensing rights; and
instructions to communicate, to the wireless device, a licensing rights validation thereby defining authenticated licensing rights.

42. At least one processor device operable at a network device and configured to perform the operations of:
receiving communication from a wireless device that includes proposed licensing rights associated with media content;
validating the proposed licensing rights; and
communicating, to the wireless device, a licensing rights validation thereby defining authenticated licensing rights.

43. A network device for validating licensing rights; the device comprising:
a computer platform that includes a processing engine and a memory unit; and
a license validation module stored in the memory unit and executed by the processing engine, wherein the license validation module is operable to validate proposed licensing rights received from the wireless communication device and communicate a licensing rights validation to the wireless communication device.

44. The device of claim 43, wherein the licensing validation module that is operable to communicate a licensing rights validation to the wireless communication device further defines the licensing rights validation as an authentication mechanism.

45. The device of claim 43, wherein the licensing validation module that is operable to communicate a licensing rights validation to the wireless communication device further defines the licensing rights validation as a content media license that includes the licensing rights, an authentication mechanism and a content identifier.

46. The device of claim 43, further comprising a security module that is operable for generating a security mechanism and associating the security mechanism with the licensing rights validation.

47. The device of claim 43, wherein the license validation module that is operable to validate proposed licensing rights received from the wireless communication device is further operable to confirm that the proposed licensing rights are in agreement with one of a licensing code or available licensing parameters.
